(19) United States
(12) Patent Application Publication
(10) Pub. No.: US 2009/0327883 A1
(43) Pub. Date: Dec. 31, 2009

(54) DYNAMICALLY ADAPTING VISUALIZATIONS

(75) Inventors: George G. Robertson, Seattle, WA (US); Jakob Peter Nielsen, Redmond, WA (US); William G. Morein, Cambridge, MA (US); Barry James Givens, Redmond, WA (US); Brian Scott Ruble, Redmond, WA (US); Christian Bernd Schormann, Seattle, WA (US); Nathan Paul McCoy, Woodinville, WA (US); Joshua Wyndham Lee, Englewood, NJ (US); Jason Joseph Weber, Burlington, IA (US); Benjamin Chronister, Duvall, WA (US); Thomas Michael Casey, Bellevue, WA (US)

Correspondence Address: Amin, Turocy & Calvin, LLP, National City Center - 24th Fl., 1900 E. 9th Street, Cleveland, OH, 44114, US

(73) Assignee: MICROSOFT CORPORATION, Redmond, WA (US)

(21) Appl. No.: 12/163,050

(22) Filed: Jun. 27, 2008

(51) Int. Cl. G06F 17/00; G06F 3/00; G06F 17/30

(52) U.S. Cl. 715/273; 715/865; 706/45; 707/102; 707/E17.044

(57) ABSTRACT

An adaptive visualization system is provided. The system includes a processing component that receives visualization configurations to determine a suitable visualization for a user. A visualization component automatically adapts a visualization output based in part on the visualization configurations. The visualization configurations can include user context inputs, user profile inputs, device characteristic inputs, or background data inputs, for example.

### BACKGROUND

To understand current software tools for visualizations, a brief review of some of the salient features of various tools is provided. Modern presentation tools enable users to communicate ideas through visual aids that appear professionally designed yet are easy to produce. The tools generally operate over a variety of media, including black and white overheads, color overheads, 35-mm slides, web pages, and on-screen electronic slide shows, for example. All these components can be integrated into a single file composing a given presentation. Whether the presentation is in the form of an electronic slide show, overheads, data visualizations, or paper print-outs, the process of creating the presentation is basically the same. For example, users can start with a template, a blank presentation, or a design template and build their respective presentations from there. To create these basic forms, there are several options provided for creating the presentation.

In one option, a series of dialog boxes can be provided that enable users to get started by creating a new presentation using a template. This can include answering questions about a presentation to end up with the ready-made slides. In another option, a blank presentation template is a design template that uses default formatting and design. These are useful if one decides on another design template after working on the presentation content or when creating custom formatting and designing a presentation from scratch. In a third option, design templates enable new users to come up to speed with the tool in a rapid manner by providing presentation templates that are already formatted to a particular style. For example, if a user wanted to make a slide with bulleted points, a design template could be selected having bullet point markers where the user could merely enter the slide points they desired to make near the markers provided. Thus, the design template is a presentation that does not contain any slides but includes formatting and design outlines. It is useful for providing presentations with a professional and consistent appearance. Thus, users can start to create a presentation by selecting a design template or they can apply a design template to an existing presentation without changing its contents.

In still another option, a presentation template is a presentation that contains slides with a suggested outline, as well as formatting and design. It is useful if one needs assistance with content and organization for certain categories of presentations such as: Training; Selling a Product, Service, or an Idea, Communicating Bad News, and so forth. When creating a new presentation using a template, users are provided a set of ready-made slides where they then replace what is on the slides with the user's own ideas while inserting additional slides as necessary. This process of making presentations while useful is essentially static in nature. Once the presentation is selected and presented, the slides generally do not change all that much unless the author of the presentation manually updates one or more slides over time.

Unfortunately, visualizations that are associated with such presentations do not account for nuances of the users. For instance, some users may experience a disability such as color blindness or dyslexia where a given output visualization is not appropriate for the respective user. Using present tools, a designer would have to be aware of the disability, redesign the visualization for that particular user, and then offer a custom product to account for that particular user's disability. As can be appreciated, such custom developments would be cost prohibitive and take a long time in development. Some software tools attempt to alter background capabilities of the respective visualization yet offer little in the way of automated adjustments. For example, a mapping tool allows users to adjust the appearance of a map based on whether or not it is a daytime or nighttime view of the map. Again, this is a static setting by the user which would cause such change in appearance. Moreover, the visualizations provided for such maps do not account for nuances or peculiarities of a particular user. Furthermore, the visualizations are adjusted based off of manual adjustments by the user as opposed to any type of automated control for the respective visualizations.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

Visualization components are provided that enables visualization output to be dynamically adapted to account for nuances and other determined context of a user. User context can be automatically gathered where a processing component automatically adjusts a visualization to account for a particular nuance or other aspect detected for a given user. The processing component can also employ various user inputs such as user profiles, environmental data, and/or device characteristics to dynamically adjust or alter visualizations in view of such inputs. Dynamic visualization concepts involve the notion that the system is able to identify what affects the proper visualization of a data item such as what type of display to render and what is absolutely important to display—for instance, taking into account physical characteristics of the user. This includes adding information about the display surface over time, where a component learns preferences and abilities to allow automated visual customization for the user.

In one aspect, a visualization system generates visualizations for someone who has a disability and automatically adapts the visualizations to their detected needs or as specified via profile, for example. The system can determine information about users and thus can dynamically adapt visualizations based on profile, color blindness, dyslexia, physical characteristics, preferences, and so forth. User information along with device and background data can provide a more appropriate visualization e.g., relating to showing a tree of visualizations, from a particular viewing perspective, swapping out or adding certain visualizations, sharing profiles to a rendering tool and so forth. Visualization components include inferring abilities of users and adapting visualizations. Thus, some understanding of goals of the user can be automatically determined, along with adapting to disabilities including: cognitive abilities; physical capabilities; physical disability; bridging people; analysis versus presentation; publishing user profiles, and so forth. Thus, provide one type of visualization when the user is analyzing data, and a distinct visualization when the user is presenting conclusions.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a schematic block diagram illustrating a system for generating adaptive visualizations.

FIG. 2 is a block diagram that illustrates alternative dynamic visualization aspects.

FIG. 3 is a flow diagram that illustrates an adaptive visualization process.

FIG. 4 illustrates a system and context component for analyzing collected user data.

FIG. 5 illustrates an exemplary system for inferring context from a data source.

FIG. 6 illustrates a system illustrates generating visualizations from contextual data.

FIG. 7 illustrates data synchronization between visualization models and applications.

FIG. 8 illustrates an example system for transitioning or morphing between dynamic display visualizations.

FIG. 9 illustrates an example visualization transition.

FIG. 10 is a schematic block diagram illustrating a suitable operating environment.

FIG. 11 is a schematic block diagram of a sample-computing environment.

### DETAILED DESCRIPTION

Systems and methods are provided to facilitate dynamic display visualizations and transitions in view of detected user context, goals, background or environmental data, or display device characteristics. In one aspect, an adaptive visualization system is provided. The system includes a processing component that receives visualization inputs to determine a suitable visualization for a user. A visualization component automatically adapts a visualization output based in part on the visualization inputs. The visualization inputs can include user context inputs, user profile inputs, device characteristic inputs, or background data inputs, for example.

As used in this application, the terms “component,” “context,” “transition,” “visualization,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

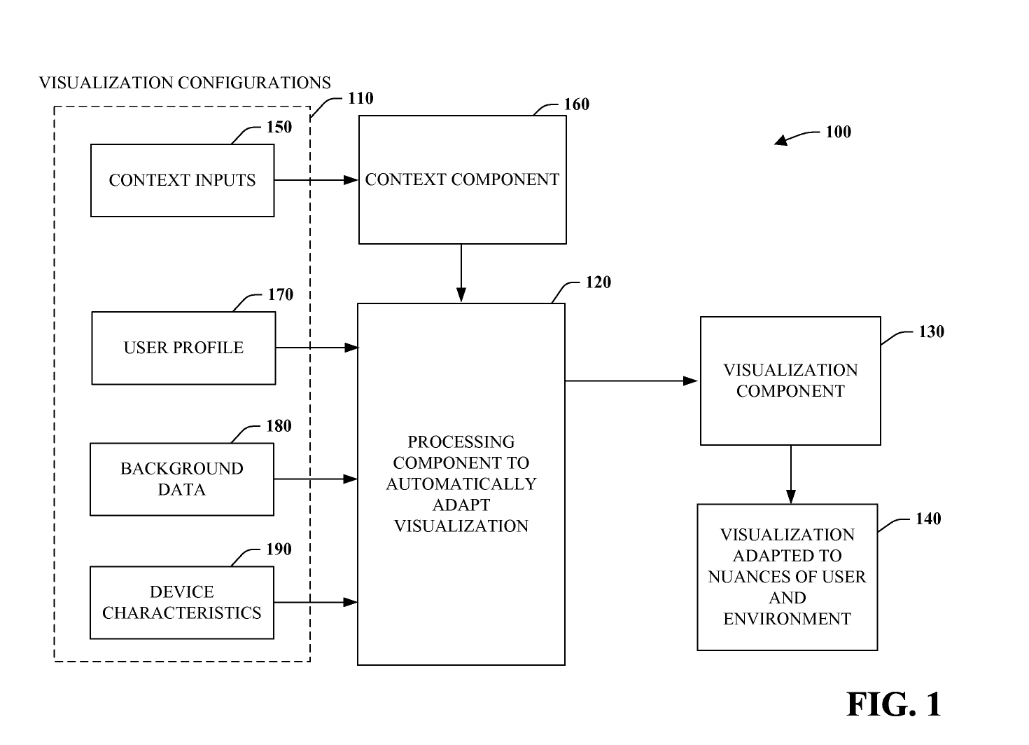

Referring initially to FIG. 1, a system 100 is illustrated for generating adaptive visualizations. One or more visualization configurations 110 are analyzed by a processing component 120, where the configurations are employed to automatically determine a suitable visualization for a user. Upon analyzing the visualization configurations 110, the processing component 120 provides output to a visualization component 130 which generates a visualization 140 (or visualizations) that has been automatically adapted to nuances of a given user and/or to the user's environment. The visualization configurations 110 can originate from several sources and employed to control dynamic adjustments in the visualization 140. In one aspect, one or more context inputs are analyzed by a context component 160, where the inputs guide intelligent and other statistical processes to determine characteristics of the user. Such characteristics can include physical capabilities or disabilities, goals, and so forth. The context component 160 can include many components for detecting a user's current context (e.g., Bayesian inference models) and is described in more detail below.

In another aspect, the visualization configurations 110 can include a user profile 170. The user profile 170 allows users to indicate or define visualization preferences that can be employed by the processing component 120 to generate dynamic visualizations 140 in accordance with the user's desires. The profile can include indications of abilities or disabilities (e.g., indicate color blindness or dyslexia), coloring options, lighting options, background visualization preferences—for example to alter the contrast of a given visualization, viewing angles, and so forth. At 180, background considerations 180 are processed. Background data 180 accounts for factors that can be manually entered or automatically detected such as ambient lighting, the user's orientation with respect to a display which can be automatically sensed, and the user's viewing angle, for example. For instance, if the processing component 120 sensed that room lighting had decreased, the visualization 140 could be lightened or employ color changes to account for the decreased lighting. If the processing component 120 senses that the visualization is being displayed in a room with green walls, the visualization could tint to colors that would not be jarring in the room. As can be appreciated, a plurality of other user profile options or background data can be considered when dynamically adjusting the visualization 140. In yet another aspect, device characteristics 190 can be considered when generating the visualization 140. Thus, one type of visualization 140 may be generated if a laptop or wall display is available or detected, and a different type of visualization may be generated if a smaller display such as a cell phone were detected. It is noted that if some detected visualization configuration 110 has changed, it is possible that other decisions based on one or more of the other visualization inputs may also change resulting in a visualization 140 that is adapted in view of the combination of detected changes.

The system 100 enables visualization output 140 to be dynamically adapted to account for nuances and other determined context of a user. User context 150 can be automatically gathered at 160 where the processing component 120 and visualization component 130 automatically adjusts the visualization 140 to account for a particular nuance or other aspect detected for a given user. The processing component 120 can also employ various user inputs such as user profiles 170, environmental or background data 180, and/or device characteristics 190 to dynamically adjust or alter visualizations in view of such inputs. Dynamic visualization concepts involve the process that the system 100 is able to identify what affects the proper visualization of a data item such as what type of display to render and what is absolutely important to display—for instance, taking into account physical characteristics of the user. This includes adding information about the display surface over time, where the context component 160 learns preferences and abilities to allow automated visual customization for the user.

In one aspect, system 100 generates visualizations for someone who has a disability and automatically adapts the visualizations 140 to their detected needs or as specified via user profile 170, for example. Thus, provide one set of data for analysis, and another set of visualizations 140 for presentations. The system 100 can determine information about users and thus can dynamically adapt visualizations 140 based on profile, color blindness, dyslexia, physical characteristics, preferences, and so forth. User information along with device data 190 and background data 180 can provide a more appropriate visualization e.g., relating to showing a tree of visualizations, from a particular viewing perspective, swapping out or adding certain visualizations, sharing profiles to a rendering tool, changing the font size, changing colors, adding hash lines to account for color-blindness, and so forth. Visualization components include inferring abilities of users and adapting visualizations 140. Thus, some understanding of goals of the user can be automatically determined, along with adapting to disabilities including: cognitive abilities; physical capabilities; physical disability; bridging people; analysis versus presentation; publishing user profiles, and so forth.

When switching to different display devices, the problems are similar to physical disability noted above in that a different display is similar to having different cognitive capabilities, a smaller display for example—a lot of visualization techniques will not be as suitable or adapting to a wall size display, for example. Thus, sensing device characteristics 190 can be employed to enable adaptable visualizations at 140. For instance, scaling and rendering regular displays to cell phone styles of display or defining different charts for displays, where the system 100 can determine what data is relevant to display. In another aspect, goals of the user can be inferred via the context component 160 to provide customize visualizations. Based on the goals, visualizations 140 can be generated that provide alternatives as to the most likely views to use e.g., these views would be suitable visualizations to provide, raising or lowering the granularity on the pieces of data one can access i.e., providing more of a guide on how to generate the components that affect the visualization. In another aspect, a visualization system 100 is provided. The system includes means for monitoring visualization input data over time (e.g., context component 160) and means for adapting at least one visualization from the data (e.g., processing component 120). The system also includes means for automatically generating the visualization (e.g., visualization component 130).

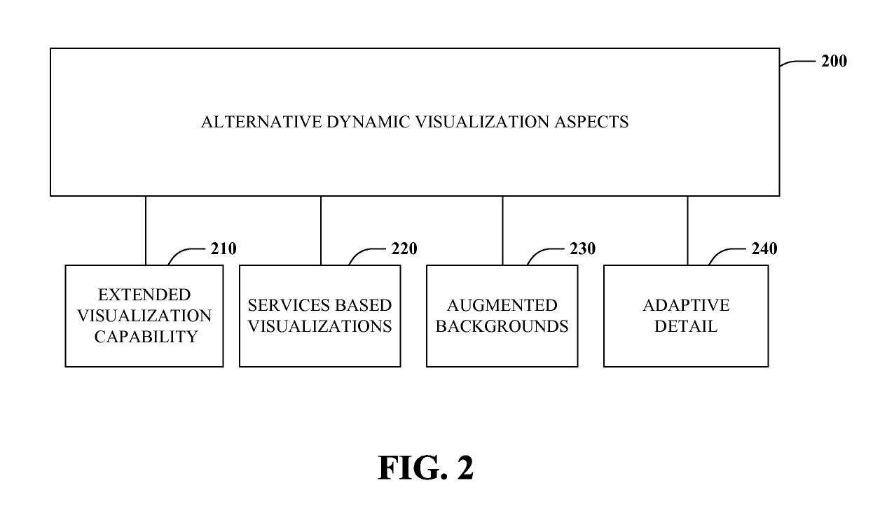

Referring now to FIG. 2, alternative dynamic visualization aspects 200 are provided that can be employed with the systems described above. Proceeding to 210, extended visualization capabilities can be provided. This includes the possibility of storing prospective visualization possibilities or renderings even though current technologies do not yet support such output. This can include models of visualization that adapt to respective form factor. For instance, it is sometimes difficult for creators of applications to keep up with advances in visualizations. Thus, separate models so that data is separate from a pre-ordained view of original author, and prioritize data so that future users know what is absolutely important for display.

At 220, services-based visualizations are considered. In this aspect, visualizations can be derived or connected from a work flow processes. This provides a services aspect to a presentation thus visualizing from a work flow process or service oriented visualizations and connecting visualizations via real time services. Similarly, real time simulation/visualization of retail or factory floor can be provided. This includes reestablishing views based on current context, mapping what is actually going on the factory floor. At 230, augmented visualization backgrounds are possible. For instance, what one is seeing physically (outside of display screen), where visualization is being augmented by what observer sees in the periphery, e.g., stitching local backgrounds into display.

At 240, adaptive detail can be provided. This can include detecting and generating views such that are based on the user's current perspective, viewing angle, nearness to the display screen, and so forth. This includes providing multiple data centers and data viewing all at once e.g., dynamically adding on a light in a data flow situation indicating that this service is slow, finding ways of deconstructing events to observe how things were constructed, providing different views, mapping multiple dimensions, moving views from one location to another, providing dynamic wall paper for visualizations, and so forth.

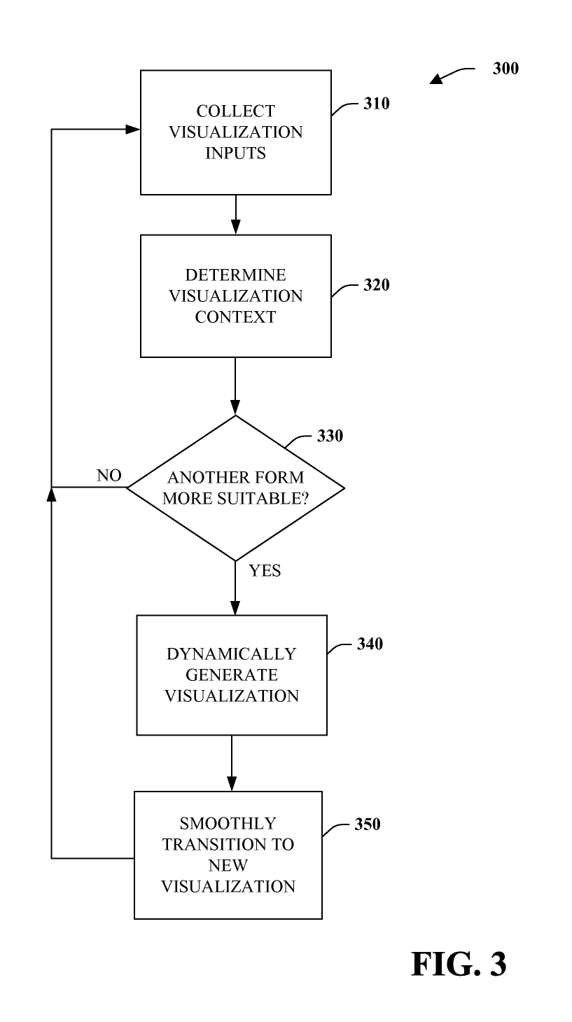

Referring now to FIG. 3, an adaptive visualization process is illustrated. While, for purposes of simplicity of explanation, the process is shown and described as a series or number of acts, it is to be understood and appreciated that the subject process is not limited by the order of acts, as some acts may, in accordance with the subject processes, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject processes described herein.

Turning to FIG. 3, an example process 300 is illustrated that performs adaptive visualizations. Proceeding to 310, data is received from one or more visualization inputs. As noted previously, such data can be collected from user context components, user profiles, background or environmental data, or by analyzing display or device characteristics. At 320, an analysis of the received data is performed in order to determine a suitable visualization context. The analysis can include observing data over time and applying the data to a suite of potential visualizations, for example. This can include selecting a visualization form, and performing a fitting analysis where statistical determinations are made as to how well a selected visualization form actually fits to a particular data set. Thresholds can be set that allow dynamic selection based off of how closely a particular visualization form maps to a particular data set. Also, various models may be stored where some models guide particular types of user capabilities or disabilities e.g., one model describes how to render images for users who suffer from dyslexia whereas another model describes renderings for color-blind users.

At 330, a determination is made as to whether or not a subsequent visualization form is more suitable for the present visualization of received visualization inputs. Subsequent analysis can include selecting other forms, performing a fitting analysis to determine suitability, and comparing to thresholds to determine if one form is a closer match than another. This can include curve fitting or other graphical techniques, regressions, and substantially any mathematical or statistical technique that enables a determination (or selection) of a suitable form in which to visualize the data. If it is found that another form is not currently more suitable for presentation at 330, the process proceeds back to 310 and continues to process visualization input data. If a more suitable form is determined at 330, the process proceeds to 340 and dynamically generates output data for a different or subsequent visualization from an initially displayed form. It is noted that automated decisions can be made to balance trade-offs. For instance, the system may continuously and repeatedly evaluate whether the VALUE of showing information in more detail or in a different form is worth the COST of changing the visualization, which may be disorienting.

The visualization forms can be substantially any display or output type including graphs, charts, trees, multi-dimensional depictions, video/audio displays describing the data, hybrid presentations where output is segmented into multiple display areas having different data analysis in each area and so forth. At 350, dynamic visualizations can include transitioning of one visualization form to another as data changes over time and subsequent visualizations are determined more appropriate for display. Controls or profiles can be provided to allow users to adjust settings for dynamic selections and how quickly one display can morph or change into another for example. After automatically transitioning to a subsequent visualization at 340 and/or 350, the process proceeds back to 310 to acquire and subsequently analyze visualization inputs.

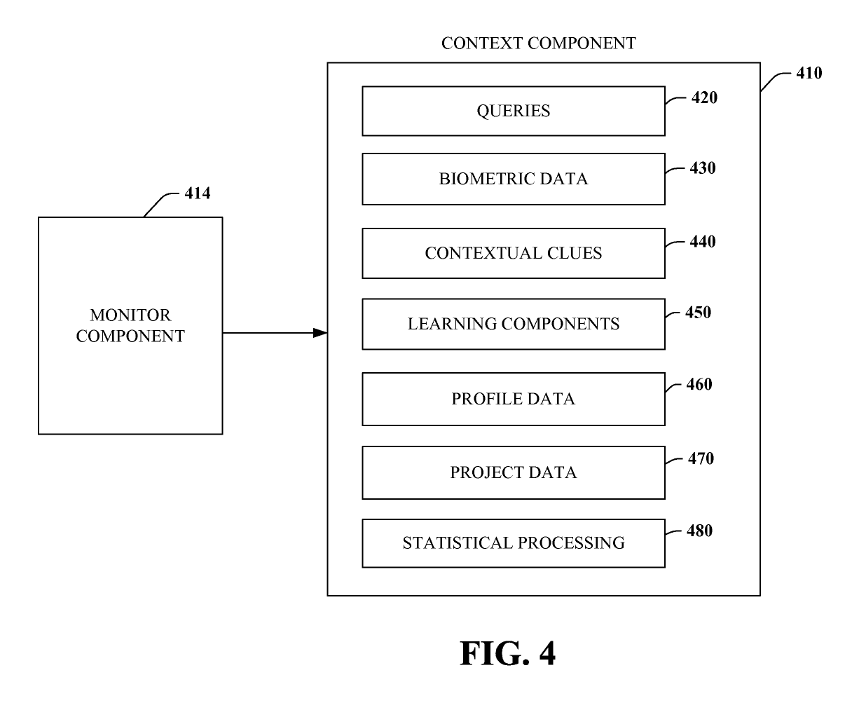

Referring now to FIG. 4, a system 400 and context component 410 for analyzing collected context data is illustrated. The context component 410 analyzes collected data such as have been previously described such as the visualization inputs described above. The context component 410 shows example factors that may be employed to analyze data to produce adaptive or augmented visualizations described above. It is to be appreciated that substantially any component that analyzes visualization input data at 414 to automatically generate adaptive visualizations can be employed.

Proceeding to 420, one aspect for capturing user actions includes monitoring queries that a respective user may make such as questions generated in a meeting or from laptop queries or other electronic media (e.g., e-mails generated from a meeting). This may include local database searches for information in relation to a given topic or slide where such query data (e.g., key words employed for search) can be employed to potentially add context to a given visualization the user may desire to view. Remote queries 420 can be processed such as from the Internet where data learned or derived from a respective query can be used to determine context for visualization.

At 430, biometric data may be analyzed. This can include analyzing keystrokes, audio inputs, facial patterns, biological inputs, and so forth that may provide clues as to how important a given piece of data is to another and based how an audience member processes the data (e.g., spending more time analyzing a slide may indicate more importance). For example, if a user were presenting a sales document for automobiles and three different competitors were concurrently analyzed, data relating to the competitors analyzed can be automatically captured by the context component 410 and saved to indicate the analysis. Such contextual data can be recovered and employed to adapt visualizations to the type of analysis currently being conducted.

At 440, one or more contextual clues may be analyzed. Contextual clues can be any type of data that is captured that further indicates some nuance to a user's thoughts or goals. For example, one type of contextual data would be to automatically detect that a user was in a meeting and thus craft a visualization to the types of display devices that were present in the meeting and in context to the meeting. This may also include noting that one of or more of the collected media streams were merely used as a background link whereas another stream was employed because the content of the stream was highly relevant to the current meeting or discussion.

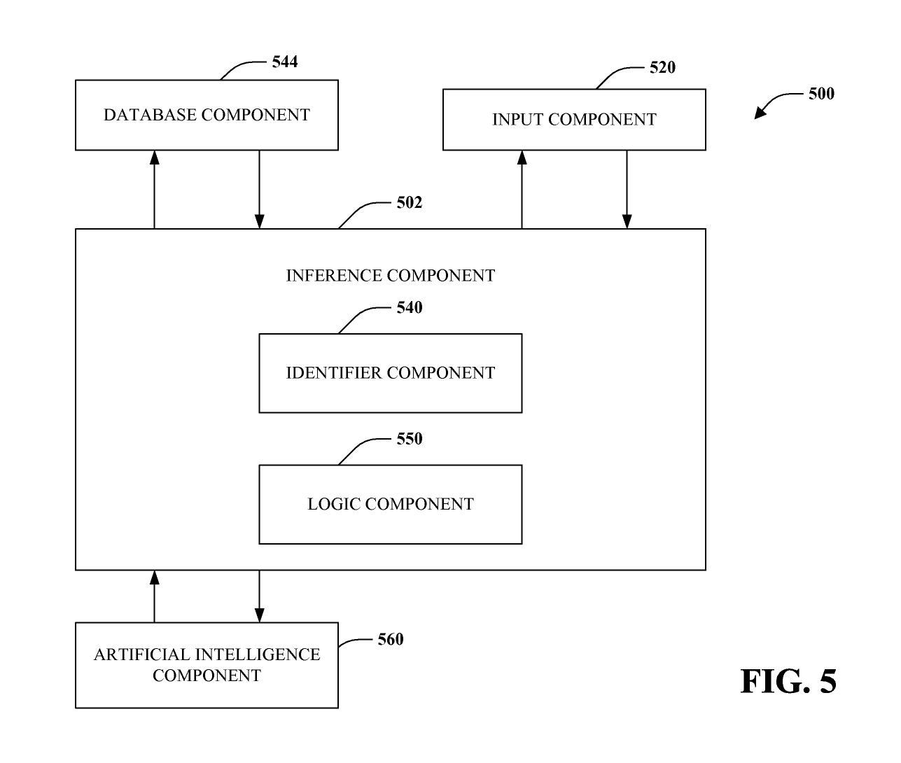

At 450, one or more learning components can be employed by the context component 410. This can include substantially any type of learning process that monitors activities over time to determine how to annotate, document, or tag data in the future. For example, a user could be monitored for such aspects as where in the visualization they analyze first, where their eyes tend to gaze, how much time they spend reading near key words and so forth, where the learning components 450 are trained over time to capture contextual nuances of the user or group. The learning components 450 can also be fed with predetermined data such as controls that weight such aspects as key words or word clues that may influence the context component 410. Learning components 450 can include substantially any type of artificial intelligence component including neural networks, Bayesian components, Hidden Markov Models, Classifiers such as Support Vector Machines and so forth and are described in more detail with respect to FIG. 5.

At 460, profile data can influence how context data is collected and visualizations are generated. For example, controls can be specified in a user profile that guides the context component 410 in its decision regarding what should and should not be included as output data with respect to a given slide or other electronic sequence. In a specific example, a systems designer specified by profile data 460 may be responsible for designing data structures that outline code in a more high level form such as in pseudo code. Any references to specific data structure indicated by the pseudo code may be noted but not specifically tagged to the higher level code assertions. Another type of user may indicate they are an applications designer and thus have preferences to capture more contextual details for the underlying structures. Still yet other type of profile data can indicate that minimal contextual data is to be captured in one context where maximal data is to be captured and thus displayed in another context.

At 470, substantially any type of project data can be captured and potentially used to add context to visualization or determine a more suitable form. This may include design notes, files, schematics, drawings, comments, e-mails, presentation slides, or other communication. This could also include audio or video data from a meeting for example where such data could be linked externally from the meeting. For example, when a particular data structure is tagged as having meeting data associated with it, a subsequent user could select the link and pull up a meeting that was conducted previously to discuss the given portion of a presentation.

At 480, substantially any type of statistical process can be employed to generate or determine contextual data. This can include monitoring certain types of words such as key words for example for their frequency, for word nearness or distance to other words in a paragraph (or other media), or substantially any type of statistical processes that is employed to indicate additional context for a processed application or data structure. As can be appreciated, substantially any type of data that is processed by a user or group can be aggregated at 410 and subsequently employed to add context to a presentation.

Referring to FIG. 5, an exemplary system 500 is provided for inferring context from various inputs and automatically adapting visualization. An inference component 502 receives a set of parameters from an input component 520. The parameters may be derived or decomposed from a specification provided by the user and parameters can be inferred, suggested, or determined based on logic or artificial intelligence. An identifier component 540 identifies suitable steps, or methodologies to accomplish the determination of a particular data item (e.g., observing a data pattern and determining a suitable presentation or augmentation). It should be appreciated that this may be performed by accessing a database component 544, which stores one or more component and methodology models. The inference component 502 can also employ a logic component 550 to determine which data component or model to use when analyzing data streams and determining a suitable visualization form. As noted previously, classifiers or other learning components can be trained from past observations where such training can be applied to an incoming data stream. From current received data streams, future predictions regarding the nature, shape, or pattern in the data stream can be predicted. Such predictions can be used to provide one or more dynamically generated visualizations as previously described.

When the identifier component 540 has identified the components or methodologies and defined models for the respective components or steps, the inference component 502 constructs, executes, and modifies a visualization based upon an analysis or monitoring of a given application. In accordance with this aspect, an artificial intelligence component (AI) 560 automatically generates contextual data by monitoring real time data as it is received. The AI component 560 can include an inference component (not shown) that further enhances automated aspects of the AI components utilizing, in part, inference based schemes to facilitate inferring data from which to augment a presentation. The AI-based aspects can be affected via any suitable machine learning based technique or statistical-based techniques or probabilistic-based techniques or fuzzy logic techniques. Specifically, the AI component 560 can implement learning models based upon AI processes (e.g., confidence, inference). For example, a model can be generated via an automatic classifier system.

It is noted that interface (not shown) can be provided to facilitate capturing data and tailoring visualizations based off the captured information. This can include a Graphical User Interface (GUI) to interact with the user or other components such as any type of application that sends, retrieves, processes, and/or manipulates data, receives, displays, formats, and/or communicates data, and/or facilitates operation of the system. For example, such interfaces can also be associated with an engine, server, client, editor tool or web browser although other type applications can be utilized.

The GUI can include a display having one or more display objects (not shown) for manipulating electronic sequences including such aspects as configurable icons, buttons, sliders, input boxes, selection options, menus, tabs and so forth having multiple configurable dimensions, shapes, colors, text, data and sounds to facilitate operations with the profile and/or the device. In addition, the GUI can also include a plurality of other inputs or controls for adjusting, manipulating, and configuring one or more aspects. This can include receiving user commands from a mouse, keyboard, speech input, web site, remote web service and/or other device such as a camera or video input to affect or modify operations of the GUI.

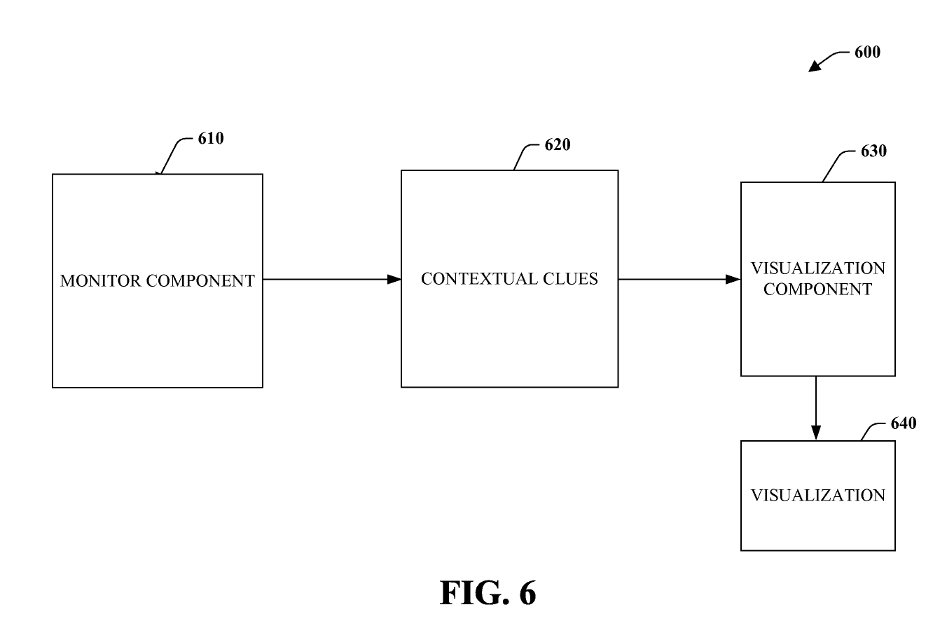

Referring now to FIG. 6, a system 600 illustrates generating visualizations from contextual data. In many cases, the monitored data previously described can be employed to add further context to existing works, other models, schemas, and so forth. Thus, a monitor component 610 that has captured some type of data context can transmit data in the form of contextual clues 620 to a visualization component 630 which employs the clues to adapt a present visualization in accordance with the user's preferences. Thus, if some data were captured by the monitor component 610 relating to a given application or presentation, such data could be transported in the form of one or more contextual clues 620. Although not shown, such data could be transformed to a different type of data structure before being transmitted to the visualization component 630. Upon receipt of such data, the visualization component 630 appends, annotates, updates, or otherwise modifies the visualization 640 to reflect the contextual clues 620 captured by the respective monitor component 610.

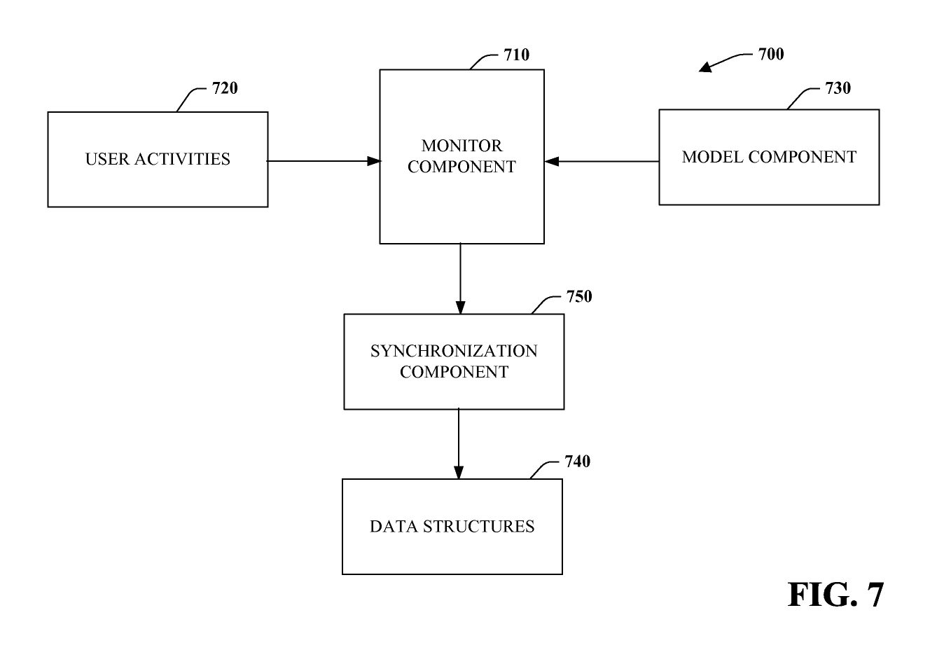

Referring to FIG. 7, a system 700 illustrates data synchronization between models and applications. A monitor component 710 analyzes observes user activities 720 over time. In accordance with such monitoring, one or more model components 730 that have been trained or configured previously are also processed by the monitor component 710. In some cases, a change in the user activities 720 may be detected where the model component 730 is updated and/or automatically adjusted. In such cases, it may be desirable to update or synchronize other data structures 740 that have previously been modified by the model component 730. For example, other data structures may include intended visualization renderings that now have to be modified in view of detected activities. As shown, a synchronization component 750 can be provided to automatically propagate a detected change to the data structures 740, where the data structures can be employed to adapt visualization data.

Other aspects can include storing entire user history for the model components 730, analyzing past actions over time, storing the patterns, detecting a link between data structures 740 and querying users if they want to maintain synchronization link or not between the data structures. Other monitoring for developing model components 730 include monitoring for biometrics such as monitoring how users are inputting data to further develop the models, analyzing the patterns and relating to a user's profile. If such data were to be considered relevant to the data structures via processing determinations, then further synchronization between structures could be performed.

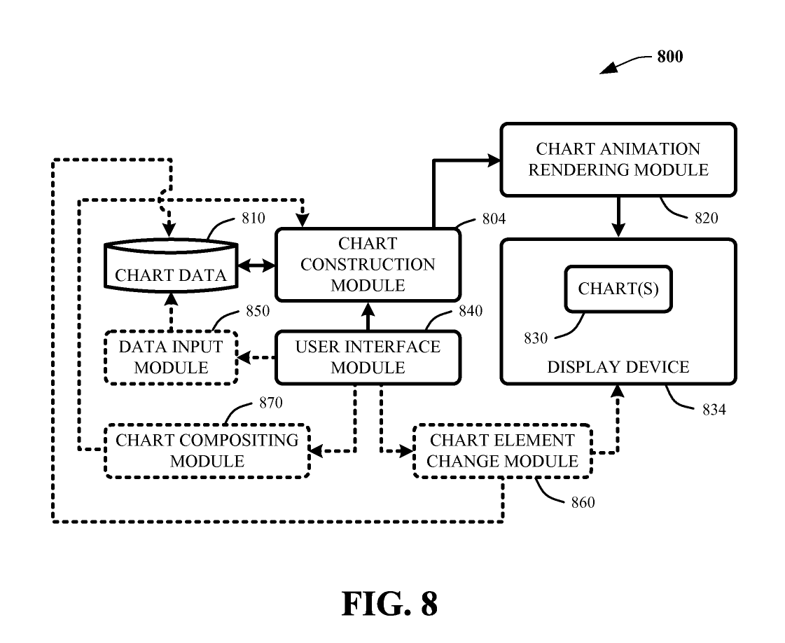

Referring to FIG. 8, an example system 800 is illustrated for transitioning or morphing between dynamic display visualizations. In general, a Charting Animator process generally begins operation by using a chart construction module 804 to define parameters used to construct one or more charts (e.g., Pie Charts, Bar Charts, Line Charts, Area Charts, Plateau Charts, etc.) using one or more sets of chart data 810. The chart construction module 804 then provides these parameters to a chart animation rendering module 820 which renders chart(s) 830 on a display device 834 (or surface).

When the chart(s) 830 have been rendered on the display device 804, changes to the rendered chart(s) are enabled using any of several aspects. For example, in one aspect, a user interface module 840 is utilized to modify one or more of data elements comprising the chart data 810 via a data input module 850. Modifications to these data elements include changing the value of one or more of the data elements, adding one or more data elements, and deleting one or more data elements. In general, these data elements are maintained in a conventional computer readable format, such as, for example, in a list, table, database, and so forth. Consequently, direct modifications to the data elements by using a user interface to change the data elements via the data input module 850 can be accomplished using conventional techniques.

When data elements have been modified, the chart construction module 804 determines new chart parameters corresponding to the modified data elements, and passes those chart parameters to the chart animation rendering module 820. At this point, the chart animation rendering module 820 then morphs the existing charts(s) 830 into new chart(s) 830 using a dynamic animation that smoothly transitions from the existing chart(s) to the new chart(s) on the display device 834.

In another aspect, changes to the rendered chart(s) 830 are enabled by directly modifying one or more elements of the chart(s), such as, for example, resizing the height of one or more bars on a Bar Chart, or changing the size of a pie slice in a Pie Chart. In various aspects, direct modification of the elements of the chart(s) is accomplished via the user interface module 840 which allows the user to select one or more individual elements of one or more charts 830 using a graphical user interface provided via a chart element change module 860. This graphical user interface provides a graphical interface to chart(s) 830 being rendered on the display device 834 for resizing, moving, sorting, or deleting one or more of those chart elements. Similarly, chart elements can also be added to one or more of the chart(s) 830 via the graphical user interface provided by the chart element change module 860.

When any chart elements have been modified (by resizing, moving, sorting, deleting, adding, etc.), the chart element change module 860 then automatically modifies the corresponding data elements of the chart data 810 (or adds new values to the chart data) to fit changes made to the chart elements. For example, if a bar in a Bar Chart originally had a value of “10,” then that bar was resized via the chart element change module 860 to show a value of “5” on the display device 834, then the chart element change module can change the value of the corresponding data element to “5” in the chart data 810.

Depending upon the chart(s) being displayed, many of the chart elements are often interdependent. Consequently, changes to one data element (either via the data input module 850, or via the chart element change module 860) used to construct the chart will often have an effect either on other data values, or on the displayed chart(s) 830. For example, if a pie slice in a Pie Chart is deleted or resized, or the underlying data value is changed, the other slices in the Pie Chart can be resized so that the Pie Chart retains a full pie shape. Therefore, when a change to data elements of the chart data 810 occurs (by any mechanism described herein), the chart construction module 804 determines new chart parameters corresponding to the modified data elements, and passes those chart parameters to the chart animation rendering module 820. At this point, the chart animation rendering module 820 then morphs the existing charts(s) 830 into new chart(s) 830 utilizing a dynamic animation that smoothly transitions from the existing chart(s) to the new chart(s) on the display device 834

In yet another aspect, a chart compositing module 870 is accessed via the user interface module 840 for creating a composite chart from two or more existing charts 830. In general, the user can use the chart compositing module 870 to specify (or select from a predefined list) some mathematical relationship between two or more existing charts 230. This mathematical relationship is then used to construct a composite chart by passing composite chart parameters to the chart construction module which in turn passes those parameters to the chart animation rendering module which acts to render the composite chart on the display device as an animation that morphs the existing charts into the composite chart.

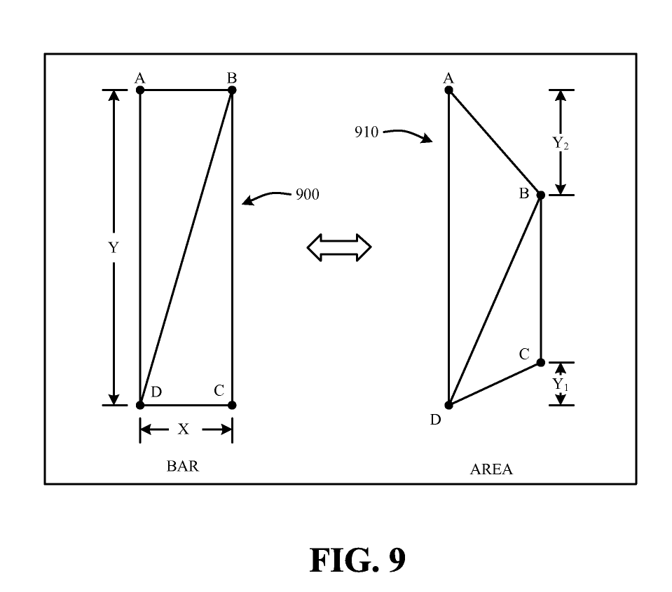

Referring to FIG. 9, an example visualization transition is illustrated. In general, the system 800 previously described has the ability to morph chart elements of one shape into chart elements of another shape, such as, for example, morphing to or from a rectangle to a line segment, area segment, or pie slice. This morphing is generally achieved by moving existing points of the various chart elements to create the new shapes, then rendering intermediate shapes to create the animated transition. Further, in addition to moving points to define a new shape, various animation components introduce new points as needed. For example, a pie slice employs many more points than a rectangular bar of a Bar Chart; so, when transitioning from a bar to a pie slice, more points are added—and when transitioning away from a pie slice, those extra points are removed.

Changing the shape of chart elements from one shape to another, such as, for example, changing a rectangular bar of a Bar Chart to a polygon of an Area Chart, or changing a rectangular bar of a Bar Chart to a pie slice of a Pie Chart is achieved by smoothly morphing the chart element from the original shape to the new shape to provide an animated transition between the shapes. This morphing can be accomplished using any of a number of morphing techniques.

For example, in one aspect, as illustrated by FIG. 9, a rectangular bar of a Bar Chart is morphed into a polygon of an Area Chart. Note that this example is not intended to limit the way in which shapes are morphed, and is provided only as a simple illustration of shape morphing techniques that may be utilized by the various animation techniques described or inferred herein.

A rectangle 900 defined by corner points {A, B, C, D} is changed to polygon 910 by translating point B by offset Y2, and translating point C by offset Y2. Clearly, any of the four points of rectangle 900 can be translated in either the X or Y direction to provide the desired shape. Similarly, translating some or all of the points, depending upon the shape, is used for scaling the shape. For example, translating two or more of points A, B and C towards (or away from) point D can be used to scale the size of rectangle 900 either up or down. Further, any one of the four points of rectangle 900 can be collapsed into another of those points to create a triangle from the rectangle 900. In any case, once the points of the new shape have been determined, the animation from the original shape to the new shape is created by simply rendering a sequence of intermediate images in steps as small as one pixel for each point, over some period of time. As can be appreciated, a plurality of various shapes, forms, and associated dimensions can be morphed or transitioned from one shape or form to another.

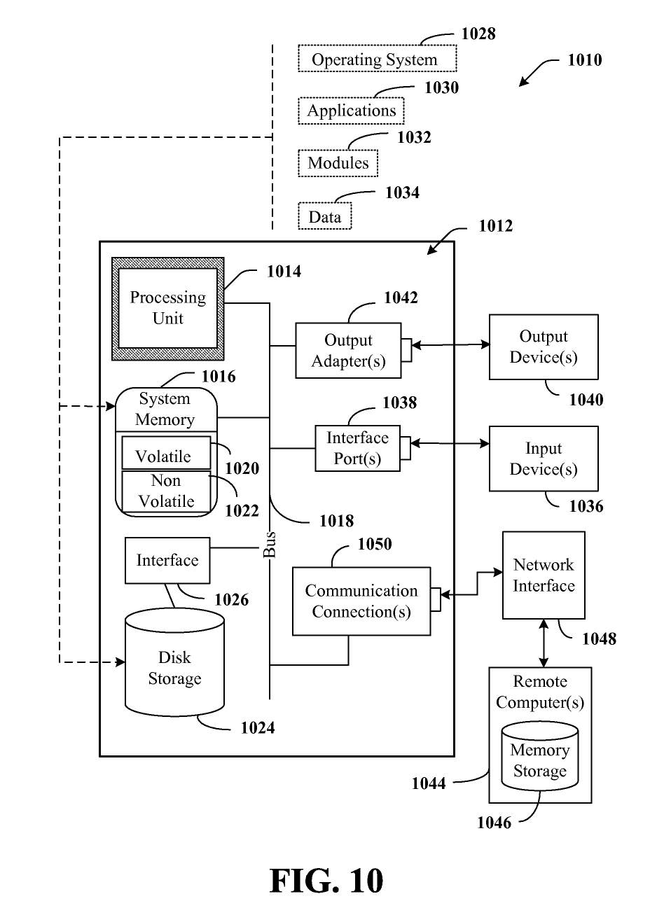

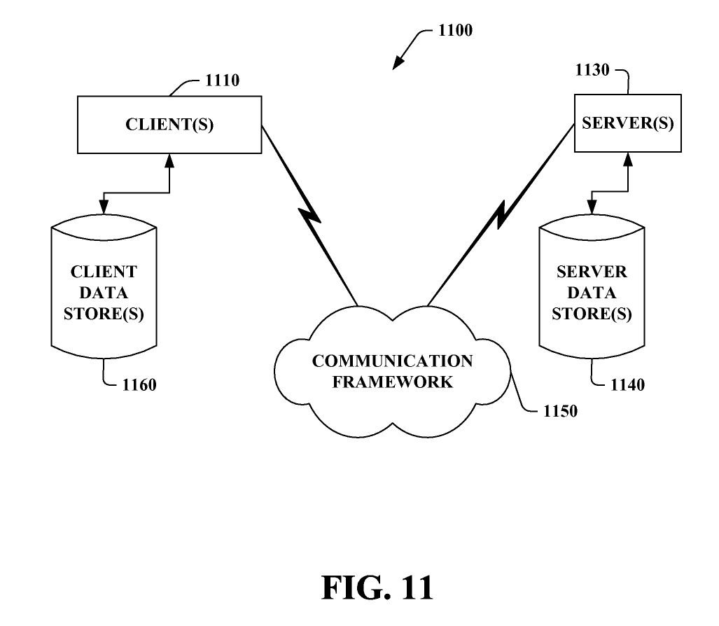

In order to provide a context for the various aspects of the disclosed subject matter, FIGS. 10 and 11 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the invention also may be implemented in combination with other program modules. Generally, program modules include routines, programs, components, data structures, etc. that performs particular tasks and/or implements particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the invention can be practiced on stand-alone computers. In a distributed computing environment, program modules may be located in both local and remote memory storage devices.

With reference to FIG. 10, an exemplary environment 1010 for implementing various aspects described herein includes a computer 1012. The computer 1012 includes a processing unit 1014, a system memory 1016, and a system bus 1018. The system bus 1018 couple system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, 64-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable ROM (EEPROM), or flash memory. Volatile memory 1020 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1012 also includes removable/non-removable, volatile/non-volatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in suitable operating environment 1010. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that various components described herein can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012 and to output information from computer 1012 to an output device 1040. Output adapter 1042 is provided to illustrate that there are some output devices 1040 like monitors, speakers, and printers, among other output devices 1040 that require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

FIG. 11 is a schematic block diagram of a sample-computing environment 1100 that can be employed. The system 1100 includes one or more client(s) 1110. The client(s) 1110 can be hardware and/or software (e.g., threads, processes, computing devices). The system 1100 also includes one or more server(s) 1130. The server(s) 1130 can also be hardware and/or software (e.g., threads, processes, computing devices). The servers 1130 can house threads to perform transformations by employing the components described herein, for example. One possible communication between a client 1110 and a server 1130 may be in the form of a data packet adapted to be transmitted between two or more computer processes. The system 1100 includes a communication framework 1150 that can be employed to facilitate communications between the client(s) 1110 and the server(s) 1130. The client(s) 1110 are operably connected to one or more client data store(s) 1160 that can be employed to store information local to the client(s) 1110. Similarly, the server(s) 1130 are operably connected to one or more server data store(s) 1140 that can be employed to store information local to the servers 1130. It is noted that some of the computation may be performed on either side of a network, with a thin visualization being local. Similarly, mobile devices such as a cell phone can be applicable for visualizations since there is only so much screen size, and thus making a decision about what to show is relevant.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An adaptive visualization system, comprising:
a processing component that receives visualization configurations to determine a suitable visualization for a user; and
a visualization component to automatically adapt a visualization output based in part on the visualization inputs.

2. The system of claim 1, the visualization configurations further comprising user context inputs, user profile inputs, device characteristic inputs, or background data inputs.

3. The system of claim 1, further comprising a contextual data component to enable capture of context data and to determine a user's goals or preferences.

4. The system of claim 3, the contextual data component captures audio streams, video streams, e-mails, queries, biometric data, contextual clues, and project related data.

5. The system of claim 4, the contextual data component includes learning components, profile components, and statistical processing components to process contextual data.

6. The system of claim 4, the profile component allows users to specify physical capabilities or disabilities, where visualizations are dynamically adjusted in view of the capabilities or disabilities.

7. The system of claim 6, further comprising a synchronization component to associate captured data with different portions of a visualization.

8. The system of claim 6, the profile component specifies a user's disability as color blindness or dyslexia.

9. The system of claim 1, further comprising a learning component to determine a data context for a prospective visualization.

10. The system of claim 1, further comprising a component that stores potential visualizations that are capable of being displayed with a future technology.

11. The system of claim 1, further comprising a component determine a visualization based upon a service flow process.

12. The system of claim 1, further comprising a component that augments a background of a prospective visualization according to the background of a present environment.

13. The system of claim 1, further comprising an adaptive detail component that can sense a viewing angle of location of a user and adapt a visualization in view of the viewing angle or location.

14. The system of claim 1, further comprising a scaling and rendering component to adjust a visualization according to the size of a detected display.

15. The system of claim 1, further comprising an inference component to automatically adjust the granularity of a display.

16. A visualization method, comprising:
analyzing one or more visualization inputs, the inputs including at least two of a context input, a user profile input, a background data input, and a device data input;
determining a suitable visualization from the visualization inputs;
automatically adapting a present visualization in view of the determined suitable visualization; and
automatically transitioning between the present visualization and the determined suitable visualization.

17. The method of claim 16, the visualization inputs include user context inputs, user profile inputs, device characteristic inputs, or background data inputs.

18. The method of claim 16, further comprising automatically inferring a user's context from the visualization inputs.

19. The method of claim 16, further comprising inferring a user's ability or disability from the visualization inputs.

20. A visualization system, comprising:
means for monitoring visualization input data over time;
means for adapting at least one visualization from the data; and
means for automatically generating the visualization.
